(19) United States
(12) Patent Application Publication
(10) Pub. No.: US 2019/0217563 A1
(43) Pub. Date: Jul. 18, 2019

(54) TREAD PATTERN MOLD INSERT

(71) Applicant: Bridgestone Americas Tire Operations, LLC, Nashville, TN (US)

(72) Inventor: Philip M. Severyn, Doylestown, OH (US)

(21) Appl. No.: 16/329,593

(22) PCT Filed: Aug. 30, 2017
(86) PCT No.: PCT/US17/49374

§ 371 Date: Feb. 28, 2019

Related U.S. Application Data
(60) Provisional application No. 62/384,502, filed on Sep. 7, 2016.

(51) Int. Cl. B29D 30/06

(52) U.S. Cl. CPC B29D 30/0606; B29D 2030/0612

(57) ABSTRACT

Provided is a tire mold adapted for molding a tire, the tire mold comprising a mold body. The mold body has a mold surface defined by an inner circumference surface, corresponding to the tread of a tire to be molded, and a tread pattern mold insert selectably engagable with the inner circumferential surface. When the inner circumferential surface is not engaged with the tread pattern mold insert, the mold surface has a first surface area adapted to mold a rain tread. When the inner circumferential surface is engaged with the tread pattern mold insert, the mold surface has a second surface area adapted to mold a slick tread. The second surface area is less than the first surface area.

### I. BACKGROUND

The present subject matter is directed to tires and tire forming processes. More specifically, the present subject matter is directed to tire molds and method of using tire molds.

There are multiple technical challenges present in current tire technology related to tires and forming tires. One of these challenges is manufacturing tires that are formed from the same green tire but differ in the tread formed thereon during molding. It is desirable to provide tires and tire forming molds that may quickly, cost-effectively, and at acceptable operational quality, provide tires formed from the same green tire but differ in the tread formed thereon during molding.

### II. SUMMARY

In accordance with one aspect of the present subject matter provided is a tire mold adapted for molding a tire the tire mold comprising a mold body. The mold body has a mold surface defined by an inner circumference surface, corresponding to the tread of a tire to be molded, and a tread pattern mold insert selectably engagable with the inner circumferential surface. When the inner circumferential surface is not engaged with the tread pattern mold insert, the mold surface has a first surface area adapted to mold a rain tread. When the inner circumferential surface is engaged with the tread pattern mold insert, the mold surface has a second surface area adapted to mold a slick tread. The second surface area is less than the first surface area.

Still other benefits and advantages of the present subject matter will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1A is a perspective view of one embodiment of a tire mold without a tire mold insert engaged therewith.

FIG. 1B is a view of one embodiment of a tire mold insert.

FIG. 1C is a perspective view of one embodiment of a tire mold without a tire mold insert engaged therewith.

FIG. 1D is a perspective view of one embodiment of a tire mold with a tire mold insert engaged therewith.

FIG. 2 is a perspective view of one embodiment of a receptacle occluding bolt.

FIG. 3A is a close up view of one embodiment of a tire mold without a tire mold insert engaged therewith.

FIG. 3B is a close up view of one embodiment of a tire mold with a tire mold insert engaged therewith.

### IV. DETAILED DESCRIPTION

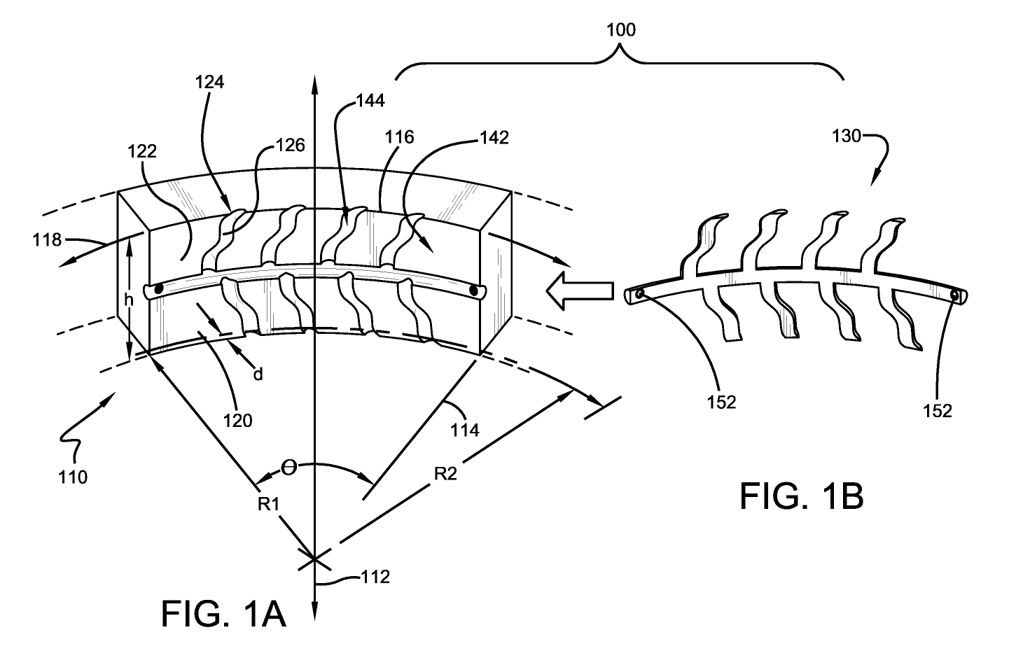

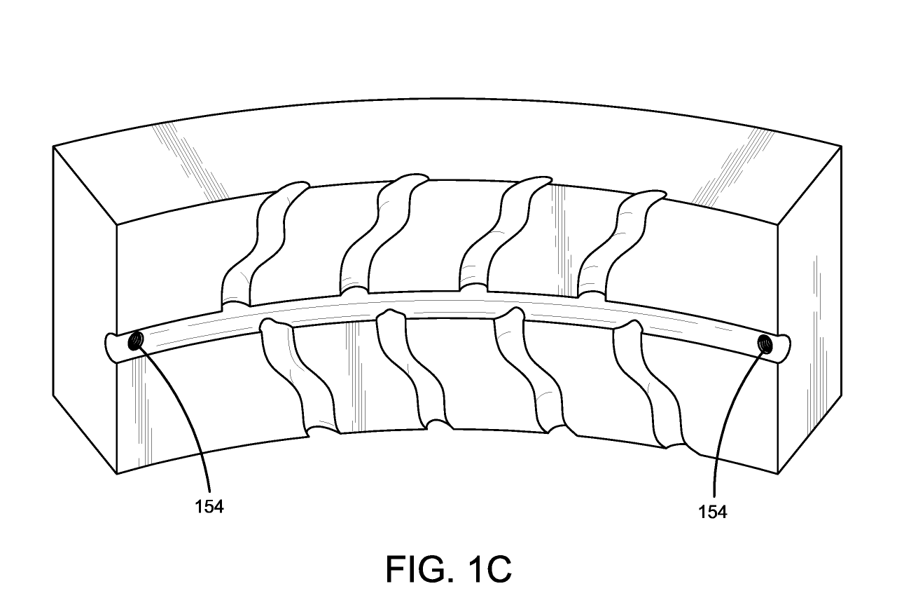

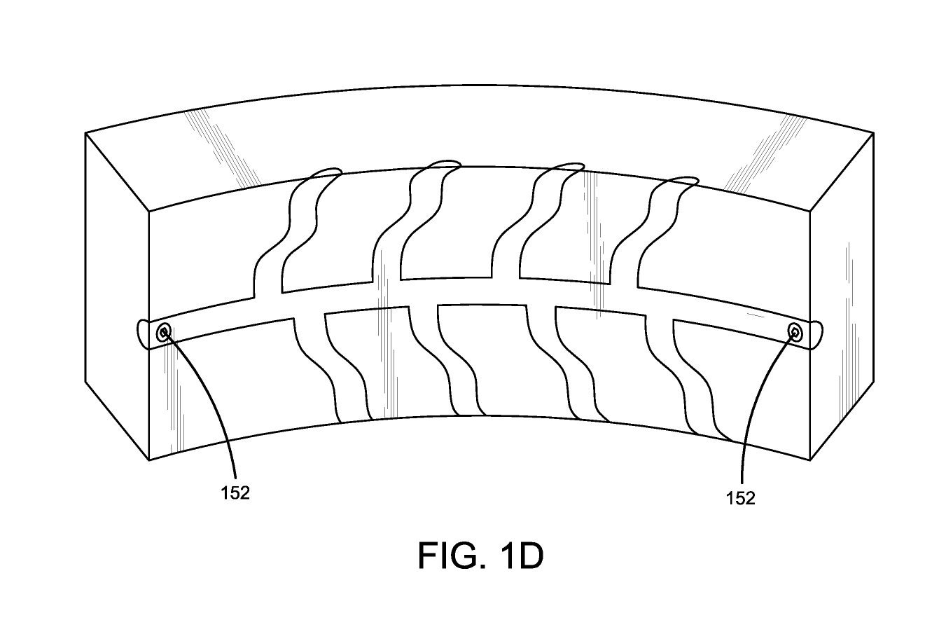

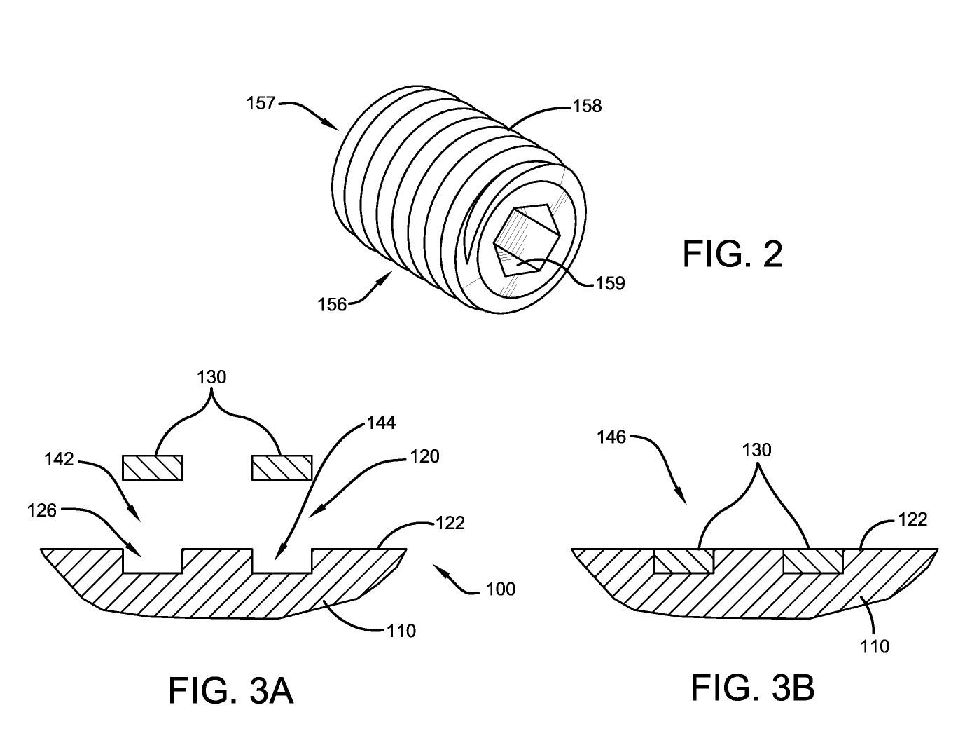

Referring now to the drawings, FIGS. 1A-3B wherein the showings are for purposes of illustrating embodiments of the present subject matter only and not for purposes of limiting the same, and wherein like reference numerals are understood to refer to like components, provided is a tire mold and a method for using same.

In certain non-limiting embodiments, a tire mold 100 may comprise a mold body 110. It should be understood that the mold body 110 shown is substantially cylindrical and is depicted with a portion in solid with the remainder of the mold body 110 removed or phantomed out for visibility. The substantially cylindrical mold body 110 may define cylindrical coordinates thereabout having an axial direction 112, a radial direction 114, and a circumference 116 defining a circumferential direction 118. The mold body 110 may have a mold surface 120 adapted to contact and mold an associated green tire. The mold surface 120 may be defined by: an inner circumferential surface 122 and a tread pattern mold insert 130. As shown in FIG. 1, the portion of the mold body 110 that is shown in solid has an inner circumferential surface 122. Inner circumferential surface 122 is generally congruent with a featureless surface defined by height in the axial direction 112 of “h”, a radius of “R₁”, and subtending an angle of “θ”. This latter general congruent condition may deviate in a manner described below due to mold features 124 to be described below. The mold surface 120 may be adapted to mold a first tread in a green tire when the inner circumferential surface 122 is not engaged with the tread pattern mold insert 130; and be adapted to mold a second tread in a green tire when the when the inner circumferential surface 122 is engaged with the tread pattern mold insert 130.

The inner circumferential surface 122 may correspond to the associated tread of the associated tire for which the mold 100 is adapted to mold, and which is to be molded in the mold 100. In certain non-limiting embodiments, the inner circumferential surface 122 may define one or more mold features 124, such as and without limitation, a groove 126, a protrusion, a blade, or some combination thereof to correspond to one or more associated tread features to be molded into the associated green tire and adapted to mold the one or more associated tread features to be molded into the associated green tire. These associated tread features may include, but are not limited to, ribs, grooves, sipes, and tread blocks. The mold features 124 may include one or more grooves 126 each of which extends into the mold body 110 by some depth, “d”. The depth “d” may differ for each groove 126, or may be the same for one or more grooves 126. As shown in FIG. 1, the depth, d, is the difference between radius R₂ and radius R₁. Similarly, in some embodiments one or mold features 124 may include one or more protrusions or blades each of which extends from the mold body 110 by some distance.

The tread pattern mold insert 130 may be selectably engageable with the inner circumferential surface 122. In certain embodiments, the inner circumferential surface 122 comprises one or more mold features 124 which are grooves 126 or other cavities and the tread mold pattern insert fits into, and thereby is adapted to fill or occlude, when operationally engaged with the inner circumferential surface 122, one or more of these latter grooves 126 or other cavities. In certain embodiments, the inner circumferential surface 122 comprises mold features 124 that are all grooves 126 or other cavities and the tread mold pattern insert fits into all of the grooves 126 or other cavities, and thereby is adapted to fill or occlude, when operationally engaged with the inner circumferential surface 122, all of these latter grooves 126 or other cavities, rendering the inner circumferential surface 122 effectively featureless and, thereby, operationally adapted to mold a slick tread, or racing slick, or other tire having a smooth tread.

As shown in FIGS. 3A and 3B, the mold 100 has a first functional state wherein the inner circumferential surface 122 is not operationally engaged with the tread pattern mold insert 130, and a second functional state wherein the inner circumferential surface 122 is operationally engaged with the tread pattern mold insert 130. In the first functional state, the mold surface presentable to, and operationally engageable with, an associated green tire, has a first surface area 142 which deviates from the above-referenced congruence with the above-referenced featureless surface by the additional surface area of the mold features 124. It should be understood that mold features, be they grooves 126, protrusions, blades, or some combination thereof, add convolutions to, and therefore a feature added surface area 144 to, the above-referenced featureless surface. It should be understood that the added surface area from the feature added surface area 144 is not necessarily the same as the sum of surface area of the mold features 124 because the mold features 124 themselves may occupy some non-zero surface area on the mold surface 120. In the first functional state, the mold 100 may be adapted to mold a tread on an associated green tire that is a rain tread, or a snow tread. In the second functional state, the mold surface 120 presentable to, and operationally engageable with, an associated green tire, has a second surface area 146. In certain embodiments, the second surface area 146 is consonant with the above-referenced congruence with the above-referenced featureless surface. In the second functional state the mold 100 may be adapted to mold a tread on an associated green tire that is a slick tread, or racing slick, or other tire having a smooth tread.

Operational engagement of the tread pattern mold insert 130 with the inner circumferential surface 122 may be made by in a variety of ways. In one embodiment, the tread pattern mold insert 130 may be adapted to be operationally engaged with the inner circumferential surface 122 by mechanical fasteners such as, without limitation, by bolts 152, pins, clips, or clamps. In certain embodiments in which the tread pattern mold insert 130 is adapted to be bolted to the inner circumferential surface 122, the inner circumferential surface 122 may comprise a conventional female threaded receptacle 154 adapted to 1) operationally engage with a bolt operationally engaged with the tread pattern mold insert 130 when the tread pattern mold insert 130 is operationally engaged with the inner circumferential surface 122, and 2) operationally engage with a receptacle occluding bolt 156 when the tread pattern mold insert 130 is not operationally engaged with the inner circumferential surface 122. An occluding bolt 156 is adapted to operationally engage with the female threaded receptacle 154 and to occlude it to prevent the female threaded receptacle 154 from becoming part of the tread mold. In certain embodiments an occluding bolt 156 may have a bolt mold surface 157 adapted to serve as part of the tread mold, a threaded surface 158 adapted to threadedly engage with one or more female threaded receptacles 154, and a tool engagement surface 159. In one embodiment, the tread pattern mold insert 130 may be adapted to be operationally engaged with the inner circumferential surface 122 magnetically such as, without limitation, by an electromagnet. In certain embodiments in which the tread pattern mold insert 130 is adapted to be magnetically engaged to the inner circumferential surface 122, the inner circumferential surface 122 may comprise an electromagnet adapted to selectably and operationally engage electromagnetically one or more ferromagnetic components of the tread pattern mold insert 130 when the tread pattern mold insert 130 is operationally engaged with the inner circumferential surface 122. This latter electromagnetic engagement may be made with a magnetic field generated by the electromagnet.

Numerous embodiments have been described, hereinabove. It will be apparent to those skilled in the art that the above methods and apparatuses may incorporate changes and modifications without departing from the general scope of the present subject matter. It is intended to include all such modifications and alterations in so far as they come within the scope of the appended claims or the equivalents thereof.

Having thus described the invention, it is now claimed:

1. A tire mold adapted for molding an associated tire, comprising:
a mold body having a mold surface defined by
an inner circumferential surface corresponding to the tread of an associated tire to be molded, and
a tread pattern mold insert selectably engageable with said inner circumferential surface;
wherein
when the inner circumferential surface is not engaged with the tread pattern mold insert, the mold surface has a first surface area adapted to mold a rain tread, and
when the inner circumferential surface is engaged with the tread pattern mold insert, the mold surface has a second surface area adapted to mold a slick tread, the second surface area being less than the first surface area.

2. The tire mold adapted for molding an associated tire of claim 1, wherein the inner circumferential surface defines one or more mold features including a groove, a protrusion, a blade, or some combination thereof.

3. The tire mold adapted for molding an associated tire of claim 2, wherein the inner circumferential surface defines
a first groove of a first depth; and
a second groove of a second depth, where the second depth differs from the first depth.

4. The tire mold adapted for molding an associated tire of claim 3, wherein the tread mold pattern insert is adapted to fit into and fill one or more of the grooves when operationally engaged with the inner circumferential surface.

5. The tire mold adapted for molding an associated tire of claim 3, wherein when operationally engaged with the inner circumferential surface, the tread mold pattern insert fits into and fills all of the grooves.

6. The tire mold adapted for molding an associated tire of claim 1, wherein,
the mold is substantially cylindrical having a radial direction
the first surface area defines mold features extending a maximum radius of R₂;
the second surface area is defined by a featureless surface having a maximum radius R₁; and
wherein radius R₂ is greater than radius R₁.

7. (canceled)

8. A method for changing a tire mold tread, comprising:
providing a mold body having a mold surface defined by
an inner circumferential surface corresponding to the tread of a tire to be molded, and
a tread pattern mold insert selectably engageable with said inner circumferential surface,
wherein,
when the inner circumferential surface is not engaged with the tread pattern mold insert, the mold surface has a first surface area adapted to mold a rain tread, and
when the inner circumferential surface is engaged with the tread pattern mold insert, the mold surface has a second surface area adapted to mold a slick tread, the second surface area being less than the first surface area; and
either,
1) engaging the tread pattern mold insert with the inner circumferential surface, or
2) disengaging the tread pattern mold insert from the inner circumferential surface.

9. The method for changing a tire mold tread of claim 8, wherein the inner circumferential surface defines one or more mold features including a groove, a protrusion, a blade, or some combination thereof.

10. The method for changing a tire mold tread of claim 9, wherein the inner circumferential surface defines
a first groove of a first depth; and
a second groove of a second depth, where the second depth differs from the first depth.

11. The method for changing a tire mold tread of claim 10, comprising filling all of the grooves by fitting the tread pattern mold insert into the inner circumferential surface.

12. The method for changing a tire mold tread of claim 8, comprising fitting the tread pattern mold insert into the inner circumferential surface to modify the mold surface
from the mold surface having the first surface area,
to the mold surface having the second surface area,
where the second surface area is less than the first surface area; where
the mold surface having the first surface area has a maximum radius of R₂, and
the mold surface having the second surface area has a maximum radius of R₁, and
wherein radius R₂ is greater than radius R₁.
engaging the tread pattern mold insert into the inner circumferential surface threadedly engaging bolts with female threaded receptacles in the inner circumferential surface.

13. The method for changing a tire mold tread of claim 12, further comprising removing a receptacle occluding bolt from the mold body.

14. A tire mold adapted for molding an associated tire, comprising:
a substantially cylindrical mold body having a mold surface adapted to contact and mold an associated green tire, the mold surface defined by
an inner circumferential surface corresponding to the tread of an associated tire to be molded,
the inner circumferential surface comprising mold features, where all the mold features are grooves adapted to mold an associated tread feature into the associated green tire, and
a tread pattern mold insert
adapted to fill or occlude all the mold features, and
adapted to be selectably and operationally engaged with the inner circumferential surface by a bolt; and
wherein
when the inner circumferential surface is not engaged with the tread pattern mold insert,
a receptacle occluding bolt having a bolt mold surface is operationally engaged with the mold body, and
the mold surface has a first surface area adapted to mold a rain tread, and
when the inner circumferential surface is engaged with the tread pattern mold insert,
the mold surface has a second surface area adapted to mold a slick tread,
the second surface area being less than the first surface area.

15. The tire mold adapted for molding an associated tire of claim 14, wherein
the mold surface having the first surface area has a maximum radius of R₂, and
the mold surface having the second surface area has a maximum radius of R₁, and
wherein radius R₂ is greater than radius R₁.

16. The tire mold adapted for molding an associated tire of claim 6, wherein the tread mold pattern insert is adapted to fit into and fill one or more of the grooves when operationally engaged with the inner circumferential surface.

17. The tire mold adapted for molding an associated tire of claim 6, wherein when operationally engaged with the inner circumferential surface, the tread mold pattern insert fits into and fills all of the grooves.

18. The tire mold adapted for molding an associated tire of claim 17, wherein, the mold body is adapted to be operationally engaged with a receptacle occluding bolt having a bolt mold surface when the inner circumferential surface is not engaged with the tread pattern mold insert.

19. The method for changing a tire mold tread of claim 10, comprising filling one or more of the grooves by fitting the tread pattern mold insert into the inner circumferential surface.

20. The method for changing a tire mold tread of claim 13, wherein the tread mold pattern insert is adapted to fit into and fill one or more of the grooves when operationally engaged with the inner circumferential surface.

21. The method for changing a tire mold tread of claim 13, wherein when operationally engaged with the inner circumferential surface, the tread mold pattern insert fits into and fills all of the grooves.
